(19) United States
(12) Patent Application Publication
(10) Pub. No.: US 2026/0353006 A1
(43) Pub. Date: Nov. 5, 2026

(54) ELECTROACOUSTIC TRANSDUCER

(71) Applicant: Panasonic Intellectual Property Management Co., Ltd., Osaka (JP)

(72) Inventors: Masashi NISHIDA, Osaka (JP); Ippei KIYAMA, Hyogo (JP)

(21) Appl. No.: 19/099,338

(22) PCT Filed: Apr. 10, 2023
(86) PCT No.: PCT/JP2023/014619

§ 371 Date: Jan. 28, 2025

(30) Foreign Application Priority Data
Sep. 13, 2022 (JP) 2022-145246

(51) Int. Cl. H04R 7/18; H04R 7/12; H04R 9/02; H04R 9/06

(52) U.S. Cl. CPC H04R 7/18; H04R 7/12; H04R 9/025; H04R 9/06; H04R 2400/11

(57) ABSTRACT

An electroacoustic transducer includes: a magnetic circuit; a coil; a diaphragm; a frame; and an edge, wherein the edge includes: an up-roll portion that is curved to protrude in one direction out of vibration directions of the diaphragm, the one direction being forward; and a down-roll portion that is concentrically connected to the up-roll portion and curved to protrude in an other direction out of the vibration directions, the other direction being rearward, a plurality of first bulging ridges that protrude rearward are provided on the up-roll portion, a plurality of second bulging ridges that protrude forward are provided on the down-roll portion, and a slope of the plurality of first bulging ridges and a slope of the plurality of second bulging ridges are identical when viewed from a front.

### TECHNICAL FIELD

The present disclosure relates to a device, such as a microphone or the like that converts acoustic vibrations into changes in an electrical quantity or a device, such as a loudspeaker or the like that acoustically converts changes in an electrical quantity.

### BACKGROUND ART

Patent Literature (PTL) 1 describes a conventional configuration, in a loudspeaker, which is one example of an electroacoustic transducer, in which an up-roll portion that protrudes forward and a down-roll portion that protrudes rearward are concentrically provided in an edge, in order to ensure that amounts of air displaced by amplitude in the forward-rearward direction of the edge supporting a diaphragm that vibrates are uniform, thereby inhibiting secondary distortion.

### CITATION LIST

### Patent Literature

[PTL 1] Japanese Unexamined Patent Application Publication No. H6-178387

### SUMMARY OF INVENTION

### Technical Problem

However, when an edge in which an up-roll portion and a down-roll portion are concentrically provided is used in a loudspeaker, there is a possibility that resonance may occur.

In view of this, the present disclosure overcomes this problem, and has an object to provide an electroacoustic transducer that uses an edge in which an up-roll portion and a down-roll portion are concentrically provided, thereby ensuring that amounts of air displaced during vibration of the edge are uniform, and suppressing resonance while enhancing frequency response.

### Solution to Problem

In order to achieve this object, an electroacoustic transducer includes: a magnetic circuit; a coil disposed in a magnetic gap of the magnetic circuit; a diaphragm to which the coil is connected; a frame that holds the magnetic circuit; and an edge that connects the diaphragm and the frame, wherein the edge includes: an up-roll portion that is curved to protrude in one direction out of vibration directions of the diaphragm, the one direction being forward; and a down-roll portion that is concentrically connected to the up-roll portion and curved to protrude in an other direction out of the vibration directions, the other direction being rearward, a plurality of first bulging ridges that are linear and bulge toward one of a forward direction or a rearward direction are provided on the up-roll portion, a plurality of second bulging ridges that are linear and bulge toward one of the forward direction or the rearward direction are provided on the down-roll portion, when a protrusion direction of the plurality of first bulging ridges and a protrusion direction of the plurality of second bulging ridges are different from each other, the plurality of first bulging ridges and the plurality of second bulging ridges are sloped in a same direction relative to a radial direction centered on a winding axis of the coil, and when the protrusion direction of the plurality of first bulging ridges and the protrusion direction of the plurality of second bulging ridges are identical, the plurality of first bulging ridges and the plurality of second bulging ridges are sloped in directions different from each other relative to the radial direction centered on the winding axis.

### Advantageous Effects of Invention

According to the present disclosure, torsional vibration of the diaphragm can be suppressed, and the frequency response of the electroacoustic transducer can be enhanced.

### BRIEF DESCRIPTION OF DRAWINGS

FIG. 1 is a cross-sectional view of an electroacoustic transducer.

FIG. 2 is a plan view of the electroacoustic transducer viewed from the front.

FIG. 3 is a perspective view of an edge.

FIG. 4 is a perspective view of a single first bulging ridge viewed diagonally from the front.

FIG. 5 is a perspective view of the single first bulging ridge viewed diagonally from the rear.

FIG. 6 is a diagram illustrating Example 1 of an arrangement pattern of bulging ridges.

FIG. 7 is a diagram illustrating Example 2 of an arrangement pattern of bulging ridges.

FIG. 8 is a plan view of another example of the edge viewed from the front.

### DESCRIPTION OF EMBODIMENTS

Hereinafter, an embodiment of an electroacoustic transducer will be described with reference to the drawings. It should be noted that the following embodiment is merely an example for describing the electroacoustic transducer, and is not intended to limit the scope of the electroacoustic transducer. For example, the shapes, structures, materials, elements, relative positional relationships, connection states, numerical values, formulas, and details of each of the steps and the order of the steps of the methods, and the like, described in the following embodiment are mere examples, and may include details that are not included in the following descriptions. Furthermore, although geometric expressions, such as “parallel” and “orthogonal”, may be used, these expressions are not mathematically precise indications and include substantially permissible error, deviation, and the like. Moreover, expressions, such as “simultaneous” and “identical (or the same)”, are considered to cover a substantially permissible range of meaning.

Additionally, the drawings are schematic illustrations, which may include emphasis, omission, or adjustment of proportion as necessary for the purpose of illustrating the present disclosure, and thus the shapes, positional relationships, and proportions shown may be different from actuality. Furthermore, an X-axis, Y-axis, and Z-axis, which may be shown in the figures indicate orthogonal coordinates that have been set in an arbitrary manner for the purpose of describing the figures. That is to say, a Z-axis is not necessarily an axis that extends in a vertical direction, and X and Y axes do not necessarily lie within a horizontal plane.

Furthermore, hereinafter, multiple aspects may be comprehensively described as a single embodiment. Moreover, part of the contents in the description below describes optional elements related to the present disclosure.

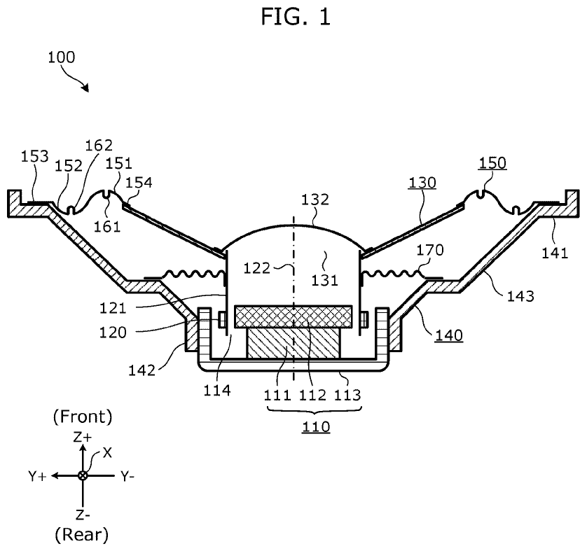

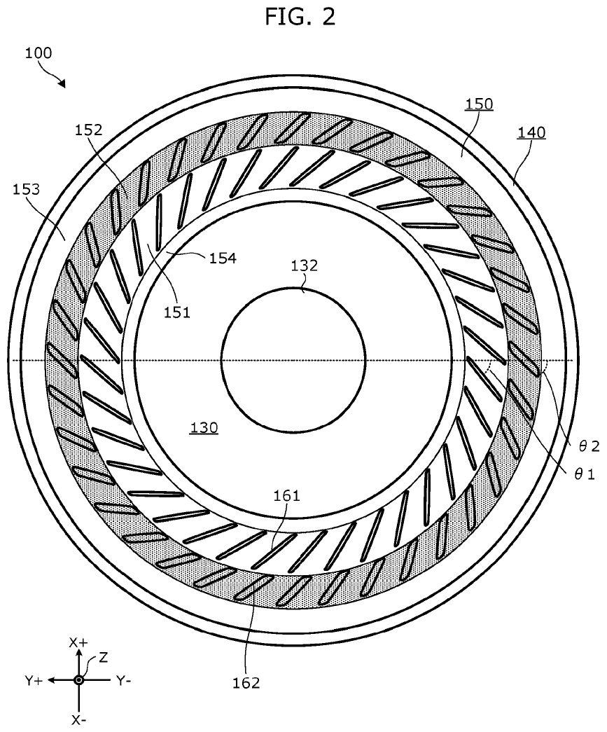

FIG. 1 is a cross-sectional view of electroacoustic transducer 100. FIG. 2 is a plan view of electroacoustic transducer 100 viewed from the front. It should be noted that FIG. 1 is a cross-sectional view cut along a plane that includes winding axis 122 of coil 120 (central axis of coil). Rather than indicating a cross section, the dotted hatching in FIG. 2 has been added to down-roll portion 152 to differentiate between up-roll portion 151 (to be described later) and down-roll portion 152 (to be described later). Furthermore, the front side (Z+ side in the figures) is the side opposite magnetic circuit 110, relative to diaphragm 130, in the direction of winding axis 122 of coil 120, and the side from which sound is emitted. Moreover, the rear side (Z− side in the figures) is the side on which magnetic circuit 110 is disposed, relative to diaphragm 130.

In the present embodiment, electroacoustic transducer 100 is provided as an example of a so-called loudspeaker that converts an acoustic signal, which represents a change in an electrical quantity, into acoustic vibrations that are vibrations of air. Electroacoustic transducer 100 includes magnetic circuit 110, coil 120, diaphragm 130, frame 140, edge 150, and damper 170.

Magnetic circuit 110 includes magnet 111 that is cylindrical and is a magnetized permanent magnet, top plate 112 that is circular board-shaped and attached to the front of magnet 111, and yoke 113 that is bottomed and cylindrical and houses magnet 111 and top plate 112. Yoke 113 is attached to the rear of magnet 111. Magnetic circuit 110 defines magnetic gap 114 that is annular, by way of the gap between top plate 112 and yoke 113. Magnet 111 generates a steady magnetic flux in magnetic gap 114. Note that although an inner-magnet type of magnetic circuit 110 is provided in the example in the present embodiment, electroacoustic transducer 100 may include an outer-magnet type of magnetic circuit 110.

Coil 120 is a coil to which an acoustic signal is input. Coil 120 is disposed in magnetic gap 114 such that winding axis 122 of coil 120 coincides with the cylindrical axis of magnetic gap 114 that is defined by magnetic circuit 110. In the present embodiment, coil 120 is wound around the outer circumference of bobbin 121 that is cylindrical, and is connected to diaphragm 130 via bobbin 121. Coil 120 moves in a reciprocal manner in the directions of winding axis 122 (Z-axis directions in the figures) due to magnetic flux that changes in accordance with audio signals generated in coil 120.

Diaphragm 130 is a component that vibrates based on vibration of coil 120, and generates acoustic vibrations, or in other words, vibrations of air. The shape of diaphragm 130 is not particularly limited, and may be a shape, such as a round-tabular shape. In the present embodiment, diaphragm 130 is in a truncated-cone shape or a so-called conical shape, and at a central portion of diaphragm 130, diaphragm hole 131 is provided in which bobbin 121 is inserted penetrating through. Furthermore, cap 132 that is dome shaped and covers diaphragm hole 131 is attached to diaphragm 130.

Frame 140 is a structural component that holds magnetic circuit 110 in a fixed manner, and holds diaphragm 130 such that diaphragm 130 can vibrate. Frame 140 includes rim portion 141 that is annular and surrounds the outer circumferential rim of diaphragm 130, holding portion 142 that holds magnetic circuit 110, and connecting portion 143 that connects rim portion 141 and holding portion 142.

Damper 170 is a component that has elasticity allowing it to support diaphragm 130 together with edge 150 in a manner in which diaphragm 130 can vibrate linearly in a direction of winding axis 122 of coil 120. In the present embodiment, damper 170 is attached in a bridge-like manner between bobbin 121 and connecting portion 143 of frame 140, and supports diaphragm 130 via bobbin 121 relative to frame 140. Note that electroacoustic transducer 100 need not include damper 170.

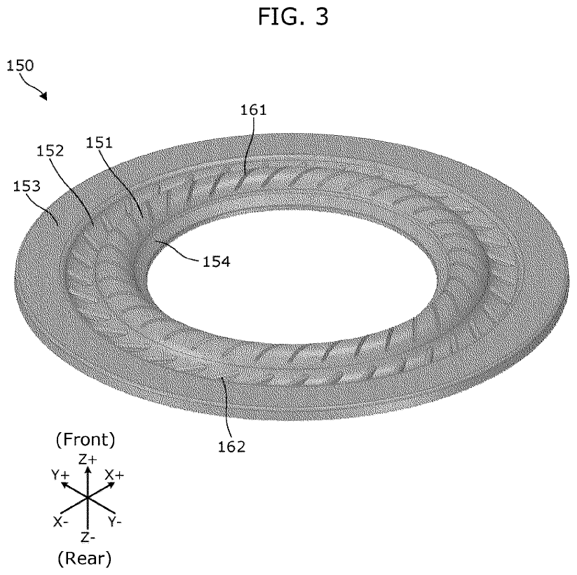

FIG. 3 is a perspective view of edge 150. Edge 150 is a component that has elasticity and connects diaphragm 130 to frame 140 in a manner in which diaphragm 130 can vibrate. There are no limitations on the material of edge 150, and examples include rubber, elastomer, and the like. Edge 150 includes up-roll portion 151 and down-roll portion 152. In the present embodiment, edge 150 includes first attachment portion 153 that is attached to rim portion 141 of frame 140 by adhesive or the like, and second attachment portion 154 that is attached to diaphragm 130 by adhesive or the like.

Up-roll portion 151 is a portion that protrudes forward, which is one direction (Z+ side in the figures) out of vibration directions (Z-axis directions in the figures) of diaphragm 130, and is a portion that is curved in an arc-like manner. Cross-sectional shapes of up-roll portion 151 cut along planes including winding axis 122 of coil 120 are identically arc-like in shape across the entire circumference of up-roll portion 151, except for a bulging ridge portion (later described in detail). First bulging ridges 161 are provided on up-roll portion 151. In the present embodiment, up-roll portion 151 is concentrically disposed inside of down-roll portion 152, and is integrally connected to down-roll portion 152.

Down-roll portion 152 is a portion that protrudes rearward, which is another direction (Z− side in the figures) out of vibration directions (Z-axis directions in the figures) of diaphragm 130, and is a portion that is curved in an arc-like manner. Cross-sectional shapes of down-roll portion 152 cut along planes including winding axis 122 of coil 120 are identically arc-like in shape across the entire circumference of down-roll portion 152, except for a bulging ridge portion (later described in detail). Second bulging ridges 162 are provided on down-roll portion 152. In the present embodiment, up-roll portion 151 is concentrically disposed inside of down-roll portion 152, and is integrally connected to down-roll portion 152.

Although the cross-sectional shapes and sizes of up-roll portion 151 and the cross-sectional shapes and sizes of down-roll portion 152 cut along planes including winding axis 122 of coil 120 are set in accordance with detailed design considerations, in the present embodiment, they are set to be identical to each other. Since down-roll portion 152 is concentrically disposed outside of up-roll portion 151, the volume of the region surrounded by down-roll portion 152 is larger than the volume of the region surrounded by up-roll portion 151. However, as the amount of air displaced in up-roll portion 151 and the amount of air displaced in down-roll portion 152 when diaphragm 130 vibrates are equivalent to each other, the inventors have found that power linearity can be enhanced and the increase of secondary distortion can be suppressed. This is because the amplitude of down-roll portion 152, which is closer to first attachment portion 153 that is attached to rim portion 141 of frame 140, is smaller than the amplitude of up-roll portion 151, which is farther from first attachment portion 153.

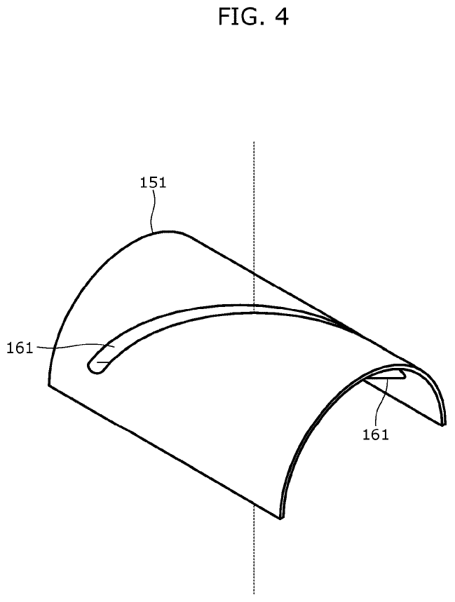

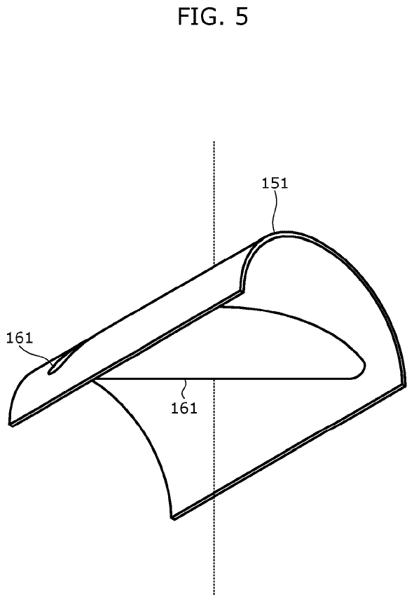

FIG. 4 is a perspective view of a single first bulging ridge 161 viewed diagonally from the front. FIG. 5 is a perspective view of the single first bulging ridge 161 viewed diagonally from the rear. In a plan view from the front, a plurality of first bulging ridges 161 that bulge in a linear manner and are sloped in the same direction relative to a radial direction (dashed line in FIG. 2) centered on winding axis 122 of coil 120 are provided on up-roll portion 151. In the same manner, second bulging ridges 162 are provided on down-roll portion 152. First bulging ridges 161 that are bulging ridges are portions that bulge in a striated manner in one of the forward direction or the rearward direction from the surface of up-roll portion 151 in the direction of winding axis 122 (dashed line in FIG. 4 and FIG. 5). Furthermore, as illustrated in FIG. 4, first bulging ridge 161 is groove shaped when viewed from one side, and as illustrated in FIG. 5, first bulging ridge 161 is rib shaped when viewed from another side. Consequently, first bulging ridge 161 can be described as a hollow rib that opens toward the side opposite of the side toward which first bulging ridge 161 is protruding. Second bulging ridge 162 is similar to first bulging ridge 161 in this regard.

In the present embodiment, as illustrated in FIG. 2, slope θ1 of first bulging ridge 161 and slope θ2 of second bulging ridge 162 are each sloped at an angle of 45 degrees, or an angle that is approximately 45 degrees. Furthermore, the direction of sloping is a direction that has been rotated at a predetermined angle (45 degrees in the present embodiment) in a clockwise direction when viewed from the front relative to the radial direction centered on winding axis 122. In this manner, by disposing first bulging ridges 161 and second bulging ridges 162 so as to be sloped in the same direction when viewed from the front (same direction even when viewed from the rear), the directions in which twisting movements occur in up-roll portion 151 and down-roll portion 152 around winding axis 122, due to the forward and rearward movement of diaphragm 130, become reversed. Here, for slope 01 of first bulging ridge 161 and slope θ2 of second bulging ridge 162, assuming that the forward direction is the clockwise direction as viewed from the front in either case, “sloped in the same direction” refers to when 0 degrees <θ1<90 degrees and 0 degrees <θ2<90 degrees are satisfied or when 0 degrees >θ1>−90 degrees and 0 degrees >θ2>−90 degrees are satisfied. Assuming that the forward direction is the clockwise direction as viewed from the front, “sloped in opposite directions” refers to when 0 degrees <θ1<90 degrees and 0 degrees >θ2>−90 degrees are satisfied or when 0 degrees >θ1>−90 degrees and 0 degrees <θ2<90 degrees are satisfied.

First bulging ridge 161 provided on up-roll portion 151 opens toward the front and protrudes rearward in a closed-off manner. Second bulging ridge 162 provided on down-roll portion 152 protrudes forward and opens toward the rear. In other words, first bulging ridge 161 that is hollow and second bulging ridge 162 that is hollow are respectively provided so as to open toward a convex surface that is the surface on the bulging side of up-roll portion 151 (front side) and a convex surface that is the surface on the bulging side of the down-roll portion 152 (rear side). Furthermore, first bulging ridge 161 and second bulging ridge 162 are respectively provided in a concave surface that is the surface on the recessed side of up-roll portion 151 (rear side) and a concave surface that is the surface on the recessed side of down-roll portion 152 (front side). The total number of first bulging ridges 161 provided on up-roll portion 151 and the total number of second bulging ridges 162 provided on down-roll portion 152 are the same.

The thickness of each of first bulging ridges 161 and the thickness of each of second bulging ridges 162 are equivalent to the thickness of other portions of up-roll portion 151 and down-roll portion 152. First bulging ridges 161 and second bulging ridges 162 extend in a straight line and are U-shaped when viewed in a cross section taken along a surface perpendicular to the directions of extension.

In electroacoustic transducer 100 as described above, as bulging ridges are provided on each of up-roll portion 151 and down-roll portion 152, structural rigidity is enhanced despite the entirety of edge 150 being wide, and each of up-roll portion 151 and down-roll portion 152 function as a so-called tangential edge that suppresses the occurrence of resonance. Furthermore, by combining up-roll portion 151 and down-roll portion 152, an amount of air displaced in edge 150 by vibration of diaphragm 130 can be made uniform, and the occurrence of secondary distortion can be suppressed.

In addition to the above-mentioned advantageous effect, since the slope at which first bulging ridges 161 are provided on up-roll portion 151 and the slope at which second bulging ridges 162 are provided on down-roll portion 152 are in the same direction, when viewed from the front, twisting generated in up-roll portion 151 and twisting generated in down-roll portion 152 are generated in opposite directions, thereby causing the twisting to cancel each other out, and making it possible to suppress the occurrence of vibration due to twisting of diaphragm 130. Consequently, coil 120 can be prevented from contacting magnetic circuit 110, and the frequency response of audio generated can be enhanced.

It should be noted that the present disclosure is not limited to the above embodiment. For example, other embodiments produced by arbitrarily combining or omitting some elements described in the present Description may be included as embodiments of the present disclosure. Moreover, the present disclosure includes variations obtained by various modifications to the above embodiment that can be conceived by those skilled in the art, so long as they do not depart from the essence of the present disclosure, that is, the intended meaning of the appended claims.

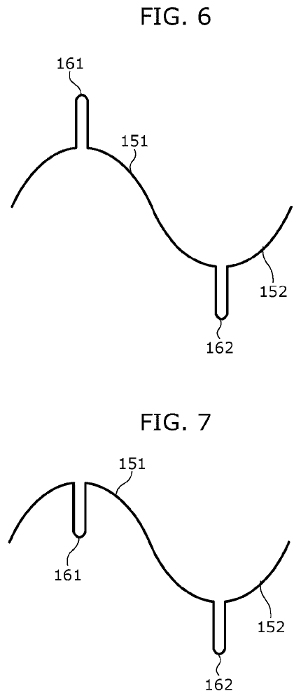

For example, although a case was described where first bulging ridges 161 are disposed to protrude from the concave surface of up-roll portion 151 and second bulging ridges 162 are disposed to protrude from the concave surface of down-roll portion 152, first bulging ridges 161 may be disposed to protrude from the convex surface of up-roll portion 151 and second bulging ridges 162 may be disposed to protrude from the convex surface of down-roll portion 152, as illustrated in FIG. 6.

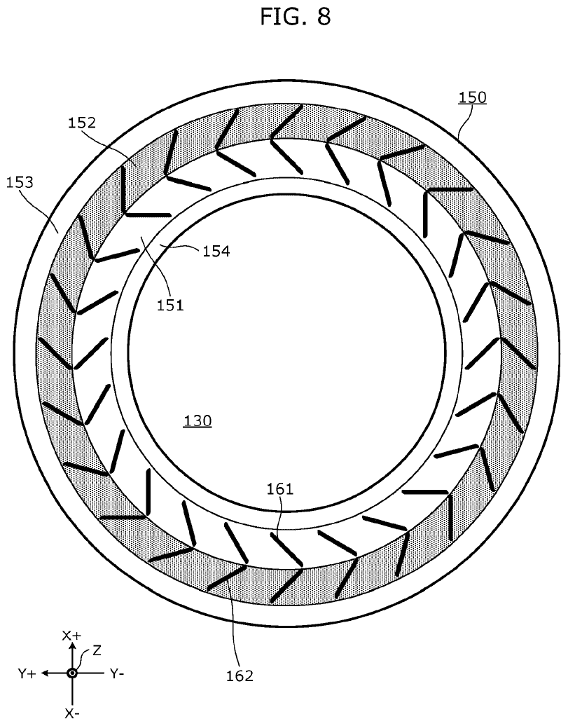

Furthermore, as illustrated in FIG. 7, first bulging ridges 161 may be disposed to protrude from the concave surface of up-roll portion 151 and second bulging ridges 162 may be disposed to protrude from the convex surface of down-roll portion 152, and conversely, first bulging ridges 161 may be disposed to protrude from the convex surface of up-roll portion 151 and second bulging ridges 162 may be disposed to protrude from the concave surface of down-roll portion 152. In this case, as illustrated in FIG. 8, first bulging ridges 161 and second bulging ridges 162 are disposed such that the slope of first bulging ridges 161 and the slope of second bulging ridges 162 are different from each other, when viewed from the front in a plan view. Accordingly, twisting of up-roll portion 151 and twisting of down-roll portion 152 can be made to occur in opposite directions. In other words, for a first case where the protrusion direction of first bulging ridges 161 and the protrusion direction of second bulging ridges 162 are different from each other (see FIG. 1 and FIG. 6), and where the slope of first bulging ridges 161 and the slope of second bulging ridges 162, relative to the radial direction centered on winding axis 122, are in the same direction (see FIG. 2), and for a second case where the protrusion direction of first bulging ridges 161 and the protrusion direction of second bulging ridges 162 are the same (see FIG. 7), and where the slope of first bulging ridges 161 and the slope of second bulging ridges 162, relative to the radial direction centered on winding axis 122, are in directions that are different from each other (see FIG. 8), either the first case or the second case may be used, and in either case, twisting of the up-roll portion 151 and twisting of the down-roll portion 152 can be made to occur in opposite directions.

Furthermore, the slope of first bulging ridges 161 and the slope of second bulging ridges 162, relative to the radial direction centered on winding axis 122, need not be the same angle.

Furthermore, although first bulging ridges 161 and second bulging ridges 162 are described as extending in a straight line, in a plan view, first bulging ridges 161 and second bulging ridges 162 may be gently curved, in an S-shape or the like, in a plan view.

Furthermore, in the present embodiment, although a loudspeaker that generates audio is described as an example of electroacoustic transducer 100, electroacoustic transducer 100 may be a microphone or the like that converts acoustic vibrations of air to an electrical signal that represents a change in an electrical quantity.

Furthermore, edge 150 may include up-roll portion 151 on an outer side and may include down-roll portion 152 on an inner side. Edge 150 may include a plurality of pairs of up-roll portions 151 and down-roll portions 152.

It should be noted that the total number of first bulging ridges 161 provided on up-roll portion 151 and the total number of second bulging ridges 162 provided on down-roll portion 152 may be different from each other. However, there are cases where design is easier to implement if the total numbers are the same.

### INDUSTRIAL APPLICABILITY

The electroacoustic converter according to the present disclosure is applicable to audio-visual devices including televisions and the like, electronic devices, such as computers, smartphones, and the like, and mobile bodies, such as automobiles, and the like.

### REFERENCE SIGNS LIST

110 magnetic circuit
111 magnet
112 top plate
113 yoke
114 magnetic gap
120 coil
121 bobbin
122 winding axis
130 diaphragm
131 diaphragm hole
132 cap
140 frame
141 rim portion
142 holding portion
143 connecting portion
150 edge
151 up-roll portion
152 down-roll portion
153 first attachment portion
154 second attachment portion
161 first bulging ridge
162 second bulging ridge
170 damper

1. An electroacoustic transducer comprising:
a magnetic circuit;
a coil disposed in a magnetic gap of the magnetic circuit;
a diaphragm to which the coil is connected;
a frame that holds the magnetic circuit; and
an edge that connects the diaphragm and the frame, wherein the edge includes:
an up-roll portion that is curved to protrude in one direction out of vibration directions of the diaphragm, the one direction being forward; and
a down-roll portion that is concentrically connected to the up-roll portion and curved to protrude in an other direction out of the vibration directions, the other direction being rearward,
a plurality of first bulging ridges that are linear and bulge toward one of a forward direction or a rearward direction are provided on the up-roll portion,
a plurality of second bulging ridges that are linear and bulge toward one of the forward direction or the rearward direction are provided on the down-roll portion,
when a protrusion direction of the plurality of first bulging ridges and a protrusion direction of the plurality of second bulging ridges are different from each other, the plurality of first bulging ridges and the plurality of second bulging ridges are sloped in a same direction relative to a radial direction centered on a winding axis of the coil, and when the protrusion direction of the plurality of first bulging ridges and the protrusion direction of the plurality of second bulging ridges are identical, the plurality of first bulging ridges and the plurality of second bulging ridges are sloped in directions different from each other relative to the radial direction centered on the winding axis.

2. The electroacoustic transducer according to claim 1, wherein
the plurality of first bulging ridges provided on the up-roll portion protrude rearward,
the plurality of second bulging ridges provided on the down-roll portion protrude forward, and
a slope of the plurality of first bulging ridges and a slope of the plurality of second bulging ridges relative to the radial direction centered on the winding axis are identical.

3. The electroacoustic transducer according to claim 1, wherein
a total number of the plurality of first bulging ridges and a total number of the plurality of second bulging ridges are identical.

4. The electroacoustic transducer according to claim 1, wherein
a shape of the plurality of first bulging ridges and a shape of the plurality of second bulging ridges are equivalent.
